(19) United States
(12) Patent Application Publication
(10) Pub. No.: US 2007/0233818 A1
(43) Pub. Date: Oct. 4, 2007

(54) Recording medium storing input/output screen generation program, and method for suppressing an unreasonable screen shift

(75) Inventor: Noboru Kurumai, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/494,908

(22) Filed: Jul. 28, 2006

(30) Foreign Application Priority Data
Mar. 29, 2006 (JP) 2006-092513

(51) Int. Cl. G06F 15/16

(52) U.S. Cl. 709/219

(57) ABSTRACT

A recording medium stores a program used to direct a server machine to execute a process of generating input/output screen information for transmission to a client, and includes: a step of storing, in memory of the server machine, command information about the input/output screen information to be transmitted to a client machine; and a step of determining whether or not the request information corresponds to the command information in the same session stored in the memory when the request information is transmitted from the client machine.

### BACKGROUND OF THE INVENTION

1. Field of the Invention

The present invention relates to a framework technology for an application of a server machine, and more specifically to the technology of generating input/output screen data to be provided for a client machine.

2. Description of the Related Art

One of the processes executed an application server machine accessible by a client machine over a communication network is an input/output screen generating process. The input/output screen generating process generates a screen (for example, a response screen, etc. to be transmitted to a client machine) when, for example, a predetermined server application in a server machine is accessed by a client machine, and largely contributes to a screen transition.

In this input/output screen generating process, a parameter is normally extracted from the request information issued on the screen displayed by the client machine, the process specified by the parameter is executed by, for example, allocating it to a predetermined operation processing unit, etc., and a next response screen to transmit to the client machine is generated based on the execution result.

Thus, the server machine provides to the client machine with a screen corresponding to the request information transmitted from the client machine in the above-mentioned input/output screen generating process.

The parameter contained in the request information transmitted from the client machine can also be manipulated by a user. Normally, such a parameter manipulation is not executed. However, if the request information processed by parameter manipulations is received by the server machine, a process is executed in a different procedure (that is, in an unexpected procedure) than the normal operation procedure of the server machine.

FIG. 1 shows the screen shift of the screen generated in the input/output screen generating process when request information includes a manipulated parameter.

FIG. 1 shows, as a model, the configuration with which operation processing is allocated to each of the corresponding business classes depending on operation processes in response to the value of a parameter.

Each screen (generation screen) shown in FIG. 1 normally changes from a screen 1 to a screen 4 by pressing the button in each screen in the order of the sequence of the screens. In this example, a screen shift is superposed to show the case in which the request information manipulated as if the button on the screen 3 were pressed is transmitted to the server machine although the button on the screen 1 is to be pressed and the request information is to be transmitted to the server machine.

In the normal case, the process is executed in the business class corresponding to the command information about the button 1, and the screen 2 is to be generated as a result. However, in this case, the command information about the button 3 is received by the manipulations, and the process is executed in the business class in the order not corresponding to the command information about the button 3. As a result, the jump screen (screen 4) is generated.

Thus, in the conventional input/output screen generating process, a process other than designing a server application can be executed by manipulating a parameter included in the request information.

A patent document which discloses the information relating to the screen generating process can be the Japanese Published Patent Application No. 2004-259016. The document discloses a method for managing information about a server machine when a plurality of browsers are activated by client machines.

### SUMMARY OF THE INVENTION

The present invention aims at providing a recording medium storing an input/output screen generation program capable of changing screens in a predetermined order. The program directs a server machine to execute a process of generating input/output screen information for transmission to a client, and includes: a step of storing in memory of the server machine the command information about the input/output screen information to be transmitted to a client machine; and a step of determining whether or not the request information corresponds to the command information in the same session stored in the memory when the request information is transmitted from the client machine.

The present invention also aims at providing a method for changing screens for transmission to a client. In this method, a server machine suppresses an unreasonable screen shift when input/output screen information for transmission to a client is generated, stores the command information about the input/output screen information to transmit to a client machine in memory, determines whether or not the request information corresponds to the command information in the same session stored in the memory when the client machine transmits request information, and executes exceptional process when the request information does not correspond to the command information.

### BRIEF DESCRIPTION OF THE DRAWINGS

FIG. 1 shows a conventional unreasonable screen shift;

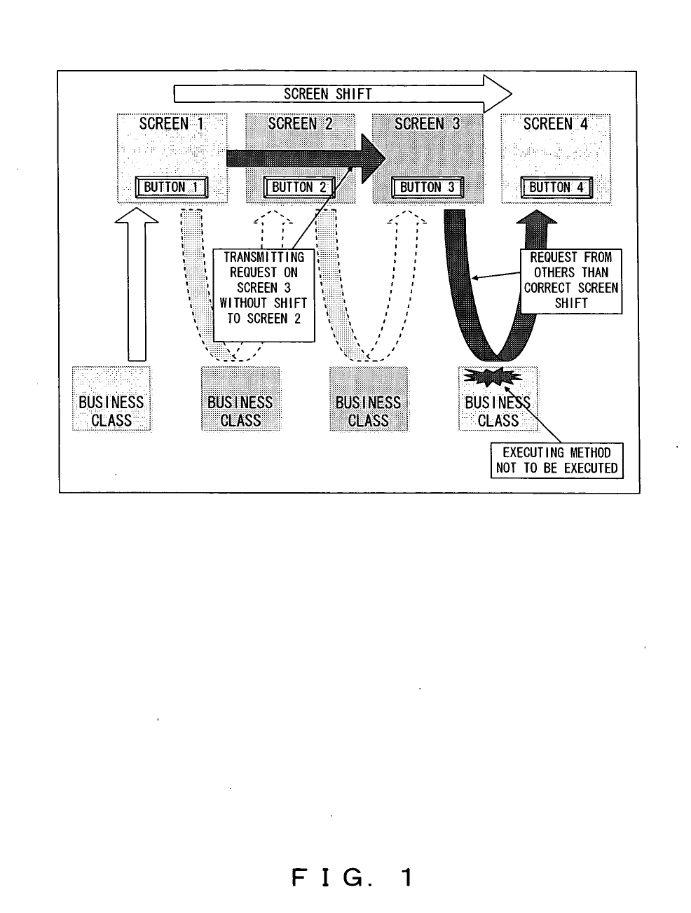

FIG. 2 shows an example of a framework;

FIG. 3 is a block diagram of the functions of the framework;

FIG. 4 is a flowchart of the program constituting the process (process in the preceding stage) of a control unit;

FIG. 5 is a flowchart of the request correctness verification process program;

FIG. 6 is a process flow of the JSP file analysis process;

FIG. 7 shows the order of the JSP file analysis process;

FIG. 8 shows a practical example of the input/output screen information of the JSP outputed from the JSP file;

FIG. 9 shows an example of the command information management table;

FIG. 10 shows an example of the configuration of the system of the server machine;

FIG. 11 shows a recording medium; and

FIG. 12 shows a transmission medium.

### DESCRIPTION OF THE PREFERRED EMBODIMENTS

One of the aspects of the recording medium according to the present invention is to store a program which directs a server machine to execute a process of generating input/output screen information for transmission to a client, and includes: a step of storing in memory of the server machine the command information about the input/output screen information to transmit to a client machine; and a step of determining whether or not the request information corresponds to the command information in the same session stored in the memory when the request information is transmitted from the client machine.

In the step of storing the command information about the input/output screen information to be transmitted to the client machine in the memory, it is preferred that it makes the server machine delete the command information previously stored in the same session when the command information is stored.

Another aspect of the recording medium of the present invention is the program used to direct a server machine to execute generating and processing the input/output screen of a Web application. The program has a business class for executing an operation processing, a session class for managing the screen of the same session using a session identification number, and plural types of JSP files, and directs the server machine to execute: a step of determining the business class based on the combination of the command name transmitted from the client machine and the data storage name; a step of determining a JSP file from the plural types of JSP files according to the result information obtained from the business class; a step of extracting the command name and a corresponding data Bean name according to the input/output screen information obtained from the JSP file, associating the session class with a session identification number, and storing the result; and determining whether or not the data Bean name and the command name correspond to the data Bean name and the command name in the same session stored in the session class when it received data Bean name and command name from a client machine; and a step of executing an exceptional process when it is determined that they do not correspond. And the program is stored in recording medium.

One of the aspects of the server machine according to the present invention, it is composed that it is possible to execute any one of programs in the above described with CPU.

One of the aspects of the methods according to the present invention is designed such that a server machine suppresses an unreasonable screen shift when input/output screen information for transmission to a client is generated, stores in memory the command information about the input/output screen information to be transmitted to a client machine, determines whether or not the request information corresponds to the command information in the same session stored in the memory when the client machine transmits request information, and executes exceptional process when the request information does not correspond to the command information.

In the present invention, screens change in a predetermined order. As if the request information unreasonably manipulated without following a due screen order is transmitted from a client, an unexpected screen shift can be suppressed.

The best mode for embodying the present invention is described below in detail by referring to the attached drawings.

First, the outline of a target to which is applied the program stored in the recording medium according to the present invention is explained, and then the program itself is explained in detail.

The program is applied on the server machine side in the communication system in which a client machine is connected to a server machine over a communication network. Especially, it is executed in the server machine (for example, an application server machine, etc.) having an environment in which an application (server application) is implemented, and the specific function of the server application is executed in the machine according to the request information from the client machine.

The program is applied to realize the input/output screen generation function (especially, the function of suppressing an unreasonable screen shift) of the server application. The input/output screen generation function is to generate input/output screen information for transmission to a client (for example, the screen information for transfer in the Http communication from a Web server to a Web browser) according to the request information from the client machine.

Described below is the program.

The program according to the present invention has the features in the following two process steps described in this program.

The first characteristic process step (first characteristic process) is to store the command information (for example, the information such as a command name, etc. issued when the client specifies and inputs a predetermined button contained in the input/output screen displayed on a Web browser) contained in the input/output screen information in the memory such as RAM (random access memory and so on) in the server machine before transmitting the input/output screen information to the client machine.

The second process step (second characteristic process) is to determine whether or not, when request information is transmitted from the client machine, the command information contained in the request information corresponds to (for example, matches or not) the command information stored in the memory. It is assumed that the determination is made on the information in the common session (same session).

If the server application including the program is implemented in the above-mentioned server machine, and executed there, then the above-mentioned two steps are executed once in a cycle from the generation process step of the input/output screen information (the screen identification number is defined as “1”) to be transmitted to the client machine to the receiving process step of receiving a response (request to the server machine) from the client of the input/output screen information having the screen identification number of “1”, and the steps are repeated in plural cycles until the session terminates.

That is, when this program is executed in the server machine, the server machine can constantly predict the command information to be received from the client machine, and when other command information is received as request information, it is detected, and the subsequent processes can be classified.

An example of a method for classifying the processes is shown below.

Described first below is the case in which each piece of command information indicates a matching result. In this case, the request information can be expected to be correct without manipulation. Therefore, in the subsequent processes, a normal input/output screen generation process is executed, and the input/output screen information according to the request information is obtained.

Described next is the case in which each piece of command information indicates a non-matching result. In this case, the request information is considered to have been manipulated. Therefore, in the subsequent processes, exceptional process is executed, and the generation of unexpected input/output screen information can be suppressed when a normal input/output screen generation process is executed according to the manipulated request information.

Thus, when the request information transmitted from the client machine is manipulated, the server machine can detect it, suppress unreasonable shift of the input/output screen provided for the client machine, and maintain the screen transition order in orderly sequence.

As described above, the program enables a server machine to realize the input/output screen generating function (especially the function of suppressing an unreasonable screen shift) of the server application. The method of implementing the program in the server machine is executed by, for example, first developing the server application including the program, and allowing the server application to be read on the memory such as RAM, ROM, etc. in the server machine. It is also possible to implement it providing the program as a framework in advance, appropriately read the framework, complete an application, and read them in the memory such as RAM, ROM, etc. of the server machine. By the program implemented in the server machine, the above-mentioned input/output screen generation function (especially the function of suppressing an unreasonable screen shift) can be realized on the server machine.

Described below is an example of the case in which this function is realized in the framework.

In this example, it is assumption that the client machine implemented with a Web browser and the server machine constituted by an application server over a communication network such as a LAN, the Internet, etc.

And above described the application server is implemented with a Web server, various programs and files for executing the above-mentioned framework, a Web application completed with the framework, etc. In this example, since the framework is constituted by a JAVA base using a servlet and JSP (Java server pages), a servlet container and a JSP container for operating them are further implemented.

With the above-mentioned configuration, the request information from the client machine is passed to the servlet/JSP container through the Web server by specifying a predetermined address from the Web browser. Then, by executing the servlet and JSP, the framework is executed according to the request information. For example, a control process, etc. is executed by the servlet, and a display process, etc. is executed by the JSP.

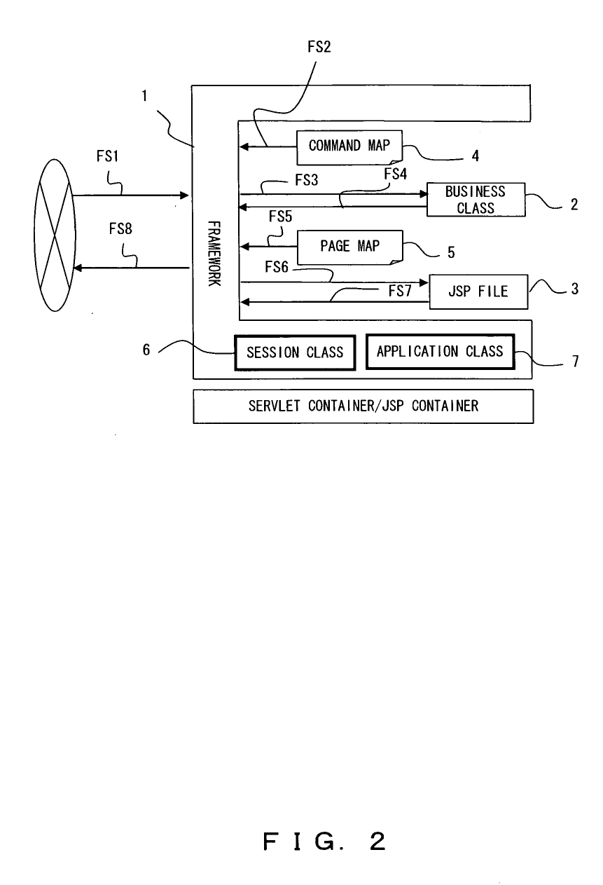

FIG. 2 shows an example of the framework.

A framework 1 is designed to execute a predetermined operation process in a business class, execute a combination process of input/output screen information to output to a client machine using a JSP file, and perform communication of information with the business class using data Bean (class of Java Bean form). Therefore, in this example, a business class 2, a JSP file 3, and the related definition file (a command map 4 and a page map 5) are prepared in advance.

As described above, since the communication of information with the business class is designed to be performed using the data Bean, the request information (practically, called a request parameter) includes the values of a data Bean name (also referred to as a data storage name) and a command name.

The business class 2 is a Java class in which a business logic is described for each operation.

The JSP file 3 is a JSP file to obtain input/output screen information provided with, for example, various types of forms.

The command map 4 is a definition file in which request information is associated with the business class 2 (to be more practical, a business class and a method). In this example, since the request information includes a command name and a data Bean name, the correspondence among a data Bean name, a command name, a business class name, and a method name is described in the command map 4.

### <Description Format>

#[class name of input data Bean] ; [command]=[business class name] ; [method name]
example) calc.BodyBean;add=calc.CalcHandler.add

Above described the page map 5 is a definition file in which the result information about the business class 2 is associated with the file name of the JSP file 3.

A session class 6 and an application class 7 is constituted in the framework. Especially, the session class 6 has a session management table for session management and a command information management table for management of command information (concretely, a data Bean name and a command name, and indicated by concretely contents as necessary in the following descriptions) as objects. In the session class, when the Web application is first accessed, the session object of the client machine is generated, and the communication between the client machine and the Web application is managed by the session identification number assigned therein for a predetermined period until the session is terminated. The former session management table is used for the management. The latter command information management table is described later.

Under the above-mentioned conditions, the entire flow of the framework 1 is described below.

In FS1, the framework 1 receives request information from the client machine, and executes the process of correctness validation for the request information using the session class. The process corresponds to the above-mentioned second characteristic process. This process is described below later in detail.

In FS2, the framework 1 refers to the command map 2, and determines the business class 4 matched for the request information.

In FS3, control is passed to the business class 4, and the business class 4 is executed.

In FS4, the execution result of the business class 4 is returned to the framework 1

In FS5, the framework 1 refers to the page map 3, and determines the JSP file 7 depending on the execution result.

In FS6, control is passed to the JSP file 7, and the JSP file 7 is executed.

In FS7, the execution result (next input/output screen information about the JSP outputed to a client machine) of the JSP file 7 is returned to the framework 1, and the framework 1 extracts command information according to the input/output screen information about the JSP, and stores the information in the input/output screen information table of the session class. These processes correspond to the above-mentioned first characteristic process (this process is also described below in detail later). In this step, a process of reflecting the result information about the business class on the input/output screen information of the JSP is also executed.

In FS8, the input/output screen information is returned to the client machine through the Web server.

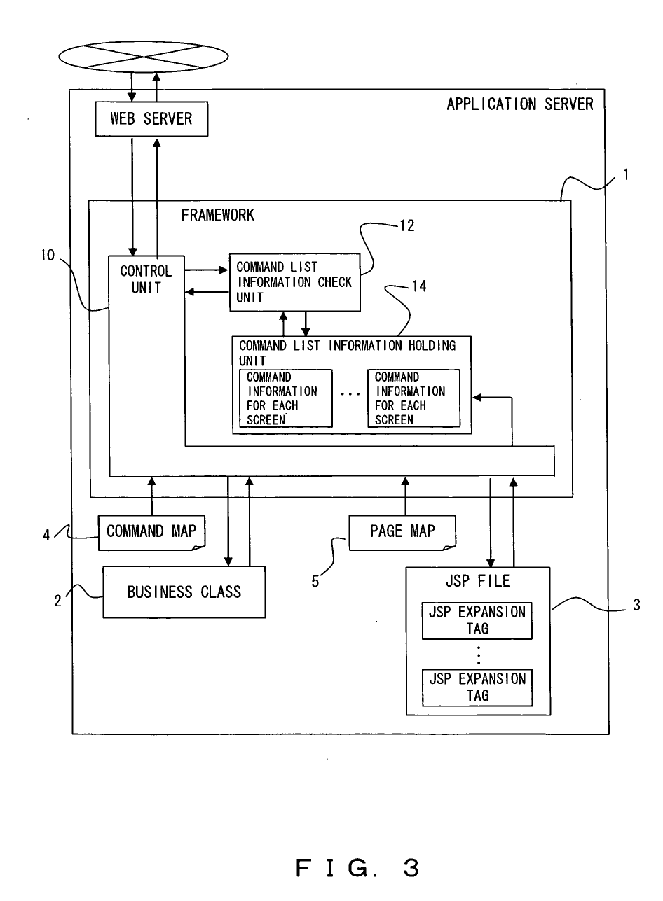

FIG. 3 is a block diagram of the functions of the framework.

In FIG. 3, communication of data and the framework with related files, related classes, etc. are also clearly shown. In these files, etc., the components the same as those shown in FIG. 2 are assigned the same reference numerals.

The framework 1 in this example is constituted by a control unit 10, a command list information check unit 12, and a command list information holding unit 14.

The control unit 10 controls the entire framework shown in FIG. 2, the process of extracting the command information from the input/output screen information about the JSP and the process (the first characteristic process) of storing these extracted command in the command list information storage unit described later.

The command list information check unit 12 is a process unit for checking the correctness of the request information received by the control unit 10 from the client. Upon receipt of the request information from the control unit 10, this process unit extracts the command information in the session to which the request information belongs from the command list information holding unit 14 described later, checks the correspondence between the request information and the command information, and returns the result information to the control unit 10.

The command list information holding unit 14 is a command information management table storing the command information. The command information management table is associated with the session management table described by, for example, a session identification number, etc., the stored command information from the control unit 10 is held for a predetermined period as associated with the session identification number, and the command information about the session identification number is passed to the command list information check unit 12 according to an extraction request from the command list information check unit. However, when the command information is stored from the control unit 10, the command information (previously stored command information) already held corresponding to the session identification number is deleted, newly stored command information is associated with the session number, and one session identification number is set as associated with only one piece of command information. When the session is disconnected, the command information is deleted.

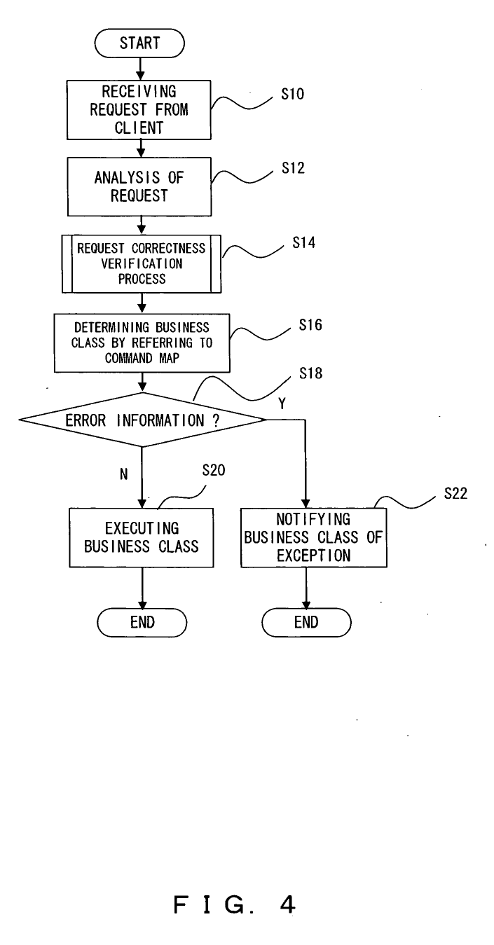

FIG. 4 is a flowchart of the program constituting a process of the control unit.

The flowchart shows the process from receiving request information to allocating a process to a business class.

Step S10 is the process of receiving request information.

Step S12 is the process of analyzing the request information, and extracting a command name and a data Bean name.

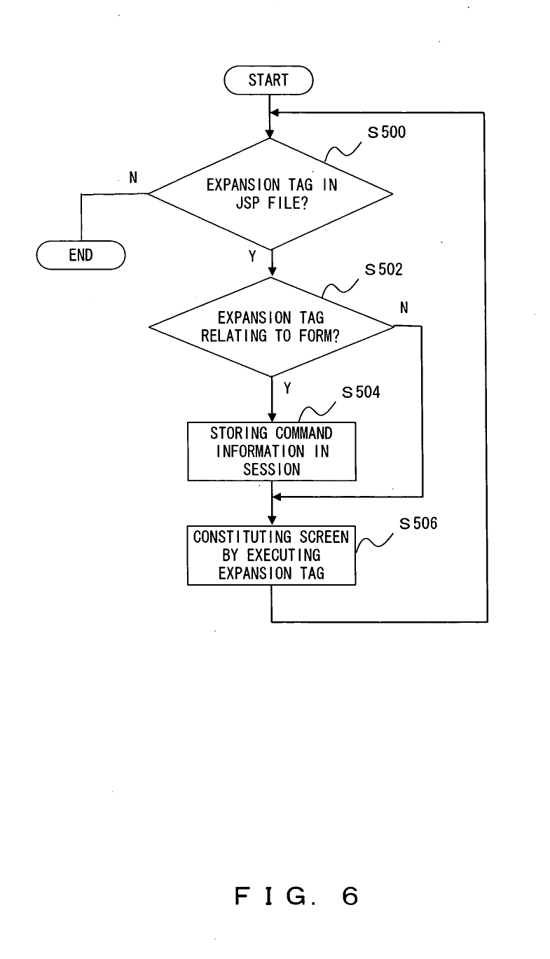

Step S14 is the process of allowing the command list information check unit 12 to execute the request correctness verification process (process shown in FIG. 6). In this process, the request parameter extracted in step S12 is passed to the command list information check unit 12, and the result of the verification process is received from the command list information check unit 12.

Step S16 is the process of determining a business class and method corresponding to the request parameter from the command map 2.

Step S18 is the process of determining whether or not error information is contained in the result of the verification process received in step S14 from the command list information check unit 12.

Step S20 is the process executed when it is determined in step S18 that the error information is not contained. In this process, the business class and the method determined in step S16 are notified of the executing process (normal process).

Step S22 is the process executed when it is determined in step S18 that the error information is contained. In this process, the business class and the method determined in step S16 are notified of the exception process (exceptional process process).

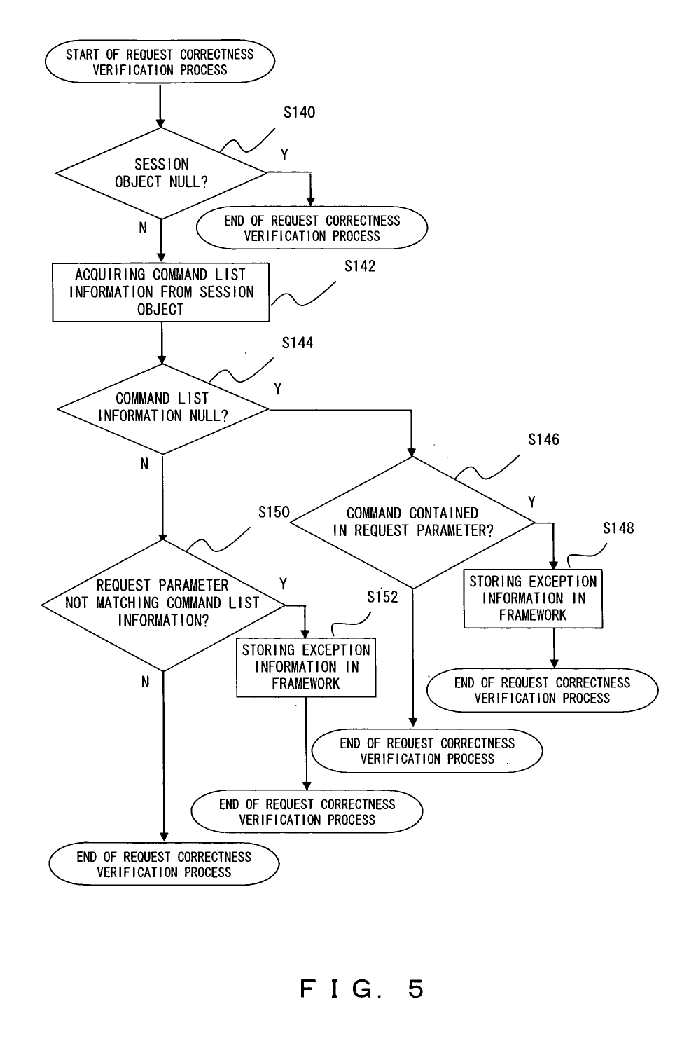

FIG. 5 is a flowchart of the request correctness verification program. The program relates to the process executed by the command list information check unit 12 on the process step S14 of the control unit shown in FIG. 4. The process described below is executed after receiving the request information from the control unit.

Step S140 is the process of determining whether or not a session has been issued to the request information.

In this process, when there is no identification information number (NULL) in the session management table, it is determined that it is the first request not assigned a session identification number, and if it is not NULL, it is determined that the request is the second or subsequent request already assigned a session number.

If it is NULL, a session identification number is issued and registered in the session management table, thereby terminating the process, and no-error information is passed to the control unit as a result of the verification process.

Step S142 is the process executed when it is determined in step S140 that it is not NULL, and the information is acquired from the command information storage position belonging to the same session from the command information management table.

Step S144 is the process of determining the presence/absence of command information. It is determined whether or not the information extracted in step S142 contains command information.

Step S146 is the process executed when it is determined in step S144 that the command information is not contained. In this process, it is determined whether or not the command information is contained in the request information. When it is determined in this process that command information isn't contained in the request information, it indicates that the screen based on which the request information is transmitted does not originally include command information. Therefore, when the determination result is outputed, it is determined that the request is correct without manipulation by a client, and the process terminates, and no-error information is passed to the control unit as a result of the verification process.

Step S148 is the process executed when it is determined in step S144 that the request information contains command information. When determination result is outputed, it is determined that the request is unreasonable with manipulation by a client machine, thereby terminating this process after storing the exceptional process, and passing error information to the control unit as a result of the verification process.

Step S150 is the process executed when it is determined in step S144 that command information is included. In this process, it is determined whether or not the command name of the command information and the data Bean name match the command name and the data Bean name in the request information. When it is determined in the process that they match, then it is determined that the command information has been correctly issued based on the screen on which the request has been transmitted. Therefore, if the determination result is outputed, the process terminates, and no-error information is passed to the control unit as a result of the verification process.

Step S152 is the process executed when it is determined in step S150 that a non-matching result is outputed. In this determination result, it is determined that the request has been unreasonably manipulated by a client machine. Therefore, the exceptional process is stored, the process terminates, and error information is passed to the control unit as a result of the verification process.

FIG. 6 is a process flow of the JSP file analysis process.

Step S500 is the process of determining whether or not there is an expansion tag (in this example, the common JSP interface (UJI)) in the input/output screen information. If it is determined that there is no expansion tag, the process terminates.

Step S502 is the process executed when it is determined in step S500 that there is an expansion tag. In this process, it is determined whether or not there is an expansion tag (FORM tag) relating to the form in which an input form is provided for a client machine. If it is determined in this process that there is no expansion tag, then the process in step S504 is skipped, and control is passed to step S506. Step S504 is the process executed when it is determined in step S502 that there is an expansion tag relating to the form. In this process, the command name and the data Bean name included in the expansion tag are included in the command information management table.

Step S506 is the process of constituting a screen according to the input/output screen information about the JSP.

A series of processes from steps S500 to S506 are executed by each of form unit on one input/output screen. When a plurality of forms are repeatedly described on one input/output screen, the process is repeated until it is executed on all forms.

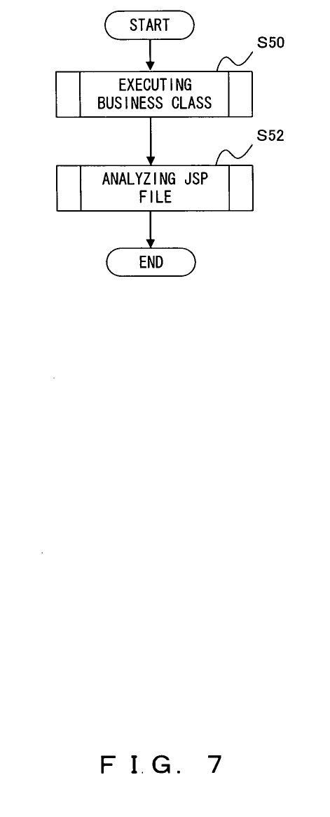

FIG. 7 shows the order of the process shown in FIG. 6 (JSP file analysis process) viewed from the control unit when the program is executed.

Step S50 is the process of the business class executed when a notification in step S20 shown in FIG. 4 is transmitted.

Step S52 is the process of analyzing the JSP file.

Thus, it is necessary to set such that the JSP file analysis process can be executed after the control unit receives the result of executed the business class.

Concretely examples of the JSP input/output screen and the command information management table are shown below.

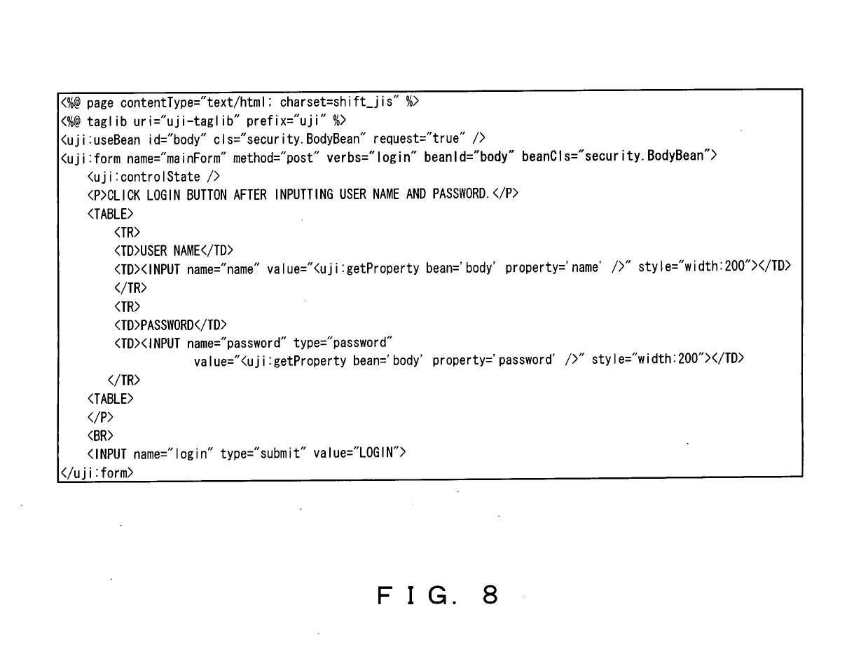

FIG. 8 shows a concretely example of an input/output screen information (that is, the input/output screen information about the JSP acquired by the control unit) about the JSP outputed from the JSP file.

As shown in FIG. 8, the input/output screen information 30 is described by the JSP.

The lines 1 and 2 are declarations, etc. of using an expansion tag (a uji tag in this example).

The line 3 defines the name (id) of data Bean corresponding to the input/output screen information. In addition, as an example of the case in which the screen of a client machine is divided into a plurality of windows or frames, the line 3 defines the information which indicate screen area corresponding to the input/output screen information (in this example, the information about the BODY area in the two areas of the HEAD area and the BODY area).

In the form tags from the line 4 to the final line, the input form to be displayed in the screen area on the client machine is described.

In this example, the start tag (<uji:form>) of the form in line 4 includes a described group of a command name for use in the input form, a corresponding data Bean name, etc. Concretely, the value (login) specified by verbs is a command name, the value (body) specified by beanId is the name of the screen area, the value (security.BodyBean) specified by BeanCls is the Bean name. The name of the screen area is replaced with the corresponding Bean name by the server machine. The client machine issues the command name (login) of the button by pressing the button in the form, and the request information including the command name together with the data Bean name transmitted to the server machine.

When the JSP file analysis process shown in FIG. 7 is executed on the input/output screen information, the command name (login) and the screen area name (body) included in the FORM tag (<uji:form>) of the input/output screen information 30, as necessary, and the data Bean name (security.BodyBean) are extracted and stored in the command information management table. The command information can be constituted by the command name and the data Bean name, but as necessary, the screen area name can be added to the data Bean name, of the data Bean name can be replaced with the screen area name.

In this example, the command information is processed as a set (a set of login and body), but when there are a plurality of sets, all of them are extracted and stored in the command information management table.

In the present example, there is only one form (from indicated by a set of a start tag (<uji:form>) and termination (</uji:form>) in one screen area (BODY area). When there are a plurality of forms, command information is extracted for each form, and stored in the command information management table.

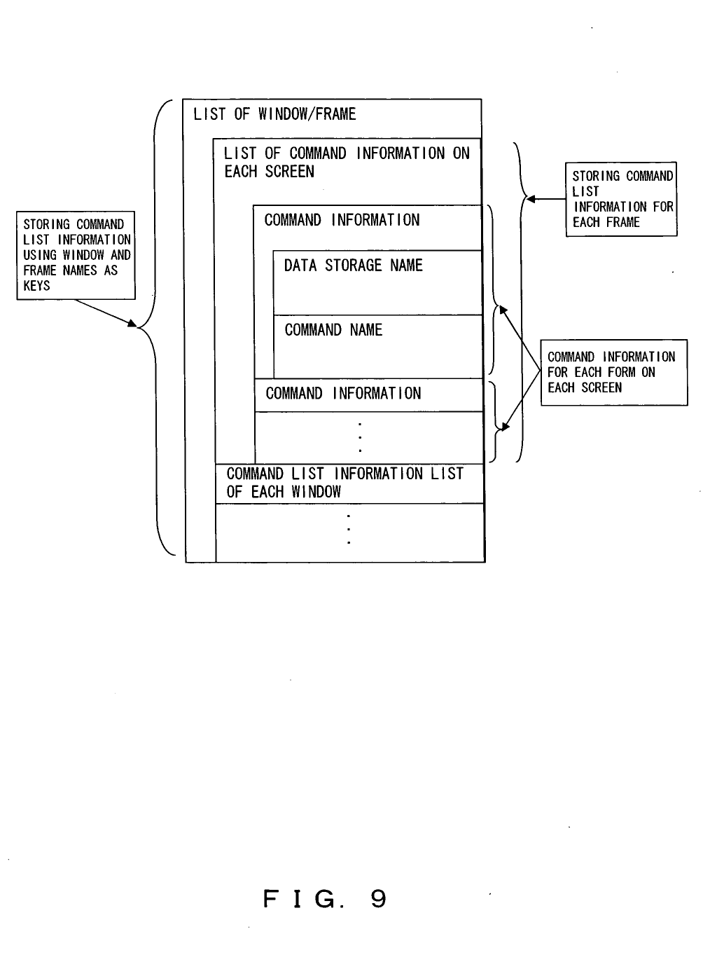

FIG. 9 shows an example of the command information management table.

Generally, in the Web application, there are a case in which there are a plurality of transmission buttons in one screen, a case in which a screen is divided in a frame, and a case in which a plurality of windows form one application. Considering these cases, in the present example, the command information is held in the following form.

The smallest unit of the command information is a combination of a data storage name (data Bean name and screen area name) and a command name. In this case, one data storage name can be combined with a plurality of command names.

The command information is held collectively for each form.

The command information collected by unit of form can be held collectively by unit of frame and unit of window.

With the above-mentioned mode, for example, a frame name and a window name can be used as a key to extract a target command information, store command information in a target area, or delete command information in a target area.

The above-mentioned program of the procedure shown in FIGS. 4 through 7, the JSP file outputting the input/output screen information about the JSP shown in FIG. 8, the command information management table shown in FIG. 9, and a Web application including a necessary file such as a definition file, a business class, etc., various program and data required as the execution environment are installed in the server machine, and activated such that the CPU can use them immediately when a request is received from a client.

Thus, the function shown in FIG. 4 is executed on the server machine, and the process flow shown in FIG. 3 is executed according to the request information transmitted from the client machine.

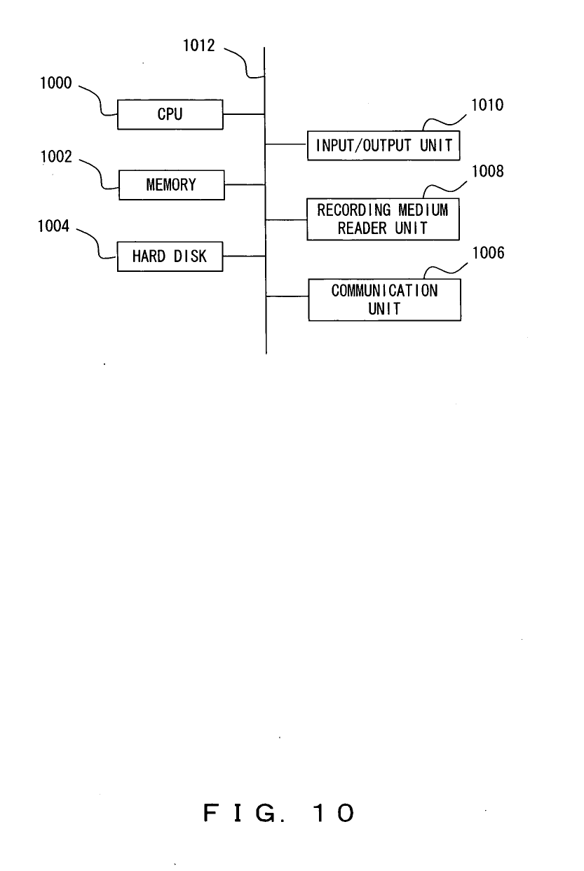

FIG. 10 shows an example of the configuration of the system of the server machine.

The server machine is constituted by a CPU (central arithmetic process unit) 1000, memory 1002 such as ROM, RAM, etc., a hard disk 1004, a communication unit 1006, a recording medium reader unit 1008, an input/output unit 1010 connected to a key board, a monitor, etc. They are connected via a bus 1012.

The program and file are read from the hard disk 1004 to the memory 1002, and the process is executed by the CPU 1000.

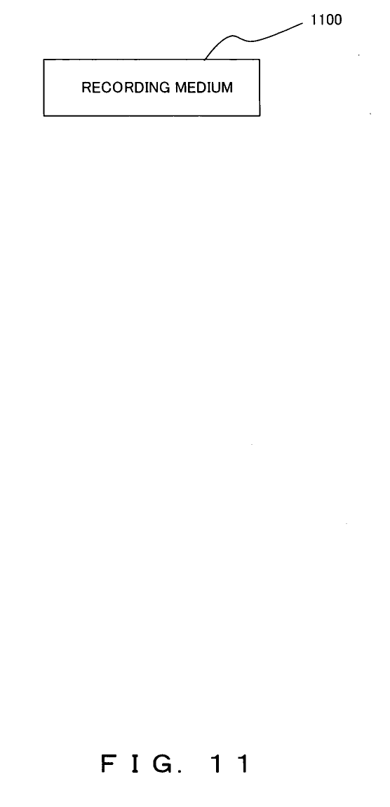

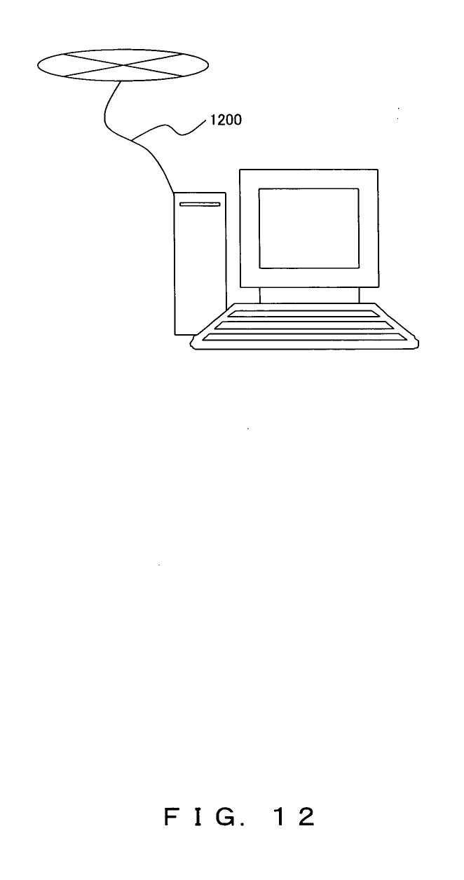

All or a part of each of above-mentioned programs and files are recorded and distributed on a recording medium 1100 such as the floppy disk (registered trademark), CD-ROM, DVD, etc. as shown in FIG. 11, or distributed through a transmission medium 1200 used in a public network, etc. as shown in FIG. 12.

Since the configuration of a user computer is the same as the configuration shown in FIG. 10, the above-mentioned case can be explained using the configuration of the server machine shown in FIG. 10. A user who receives a program and data can copy the program and the file on the hard disk 1004 through the recording medium reader unit 1008 and the communication unit 1006. Then, by reading to the memory 1002 each program and file copied to the hard disk 1004, and allowing the CPU 1000 to execute the process, each of the functions can be realized on the computer of the user.

As described above, when the request information transmitted from the client machine is manipulated, the server machine can detected it, suppress the unreasonable shift of the input/output screen to be provided for the client machine, and maintain the screen shift order in an appropriate sequence.

In the server application, a business class is designed to be executed in a predetermined order. Therefore, it is the problem if a jumping process is executed. For example, in an order system, if an order placing process is executed without a storage check process, an order is placed for supplement although there is sufficient storage. However, by generating input/output screen information in the server machine in each mode, the problem can be eliminated.

The present invention can be embodied in any other various combinations and styles without deviating from the spirit and the main feature of the present invention. Therefore, the above-mentioned embodiments are only examples, and no restrictive interpretation is allowed. The scope of the present invention is expressed by the scope of the claims for the patent, and is not restricted by the text of the specification. Furthermore, the variations and changes belonging to the scope of the claims for the patent all belong to the present invention.

What is claims is:

1. A recording medium storing a program used to direct a server machine to execute a process of generating input/output screen information for transmission to a client, comprising:
a step of storing, in memory of the server machine, command information about the input/output screen information to transmit to a client machine; and
a step of determining whether or not the request information corresponds to the command information in the same session stored in the memory when the request information is transmitted from the client machine.

2. The medium according to claim 1, wherein
in the step of storing the command information about the input/output screen information to transmit to the client in the memory, the command information stored before in the same session is deleted when the command information is stored.

3. A recording medium storing a program used to direct a server machine to execute a process of generating an input/output screen of a Web application, and having a business class for executing an operation processing, a session class for management of a screen of a same session by a session identification number, and plural types of JSP files, said program comprising:
a step of determining the business class based on a combination of a command name and a data storage name transmitted from a client machine;
a step of determining a JSP file from among the plural types of JSP files according to result information obtained from the business class;
a step of extracting the command name and a corresponding data Bean name according to input/output screen information obtained from the JSP files, and storing the session class associated with a session identification number;
a step of determining whether or not, when a data Bean name and a command name are received from a client machine, the data Bean name and the command name correspond to the data Bean name and the command name in the same session stored in the session class; and
a step of executing an exceptional process when it is determined that the names do not correspond.

4. The recording medium according to claim 3, further comprising:
extracting the command name and a corresponding data Bean name according to input/output screen information obtained from the JSP files; and
in the step of storing the session class associated with the session identification number, and when the command name and the corresponding data Bean name are associated with the session identification number and stored, deleting the command name and the data Bean name of the same session identification number stored before in the session class.

5. The recording medium according to claim 3, wherein
the command name extracted according to the input/output screen information obtain from the JSP files is a command name indicated in a position of a JSP expansion tag of the input/output screen information.

6. The recording medium according to claim 5, wherein
the command name extracted according to the input/output screen information obtain from the JSP files is a command name indicated in a position of a FORM tag of the input/output screen information.

7. A method for suppressing by a server machine an unreasonable screen shift when input/output screen information for transmission to a client is generated, comprising:
storing, in memory, command information about the input/output screen information to transmit to a client machine;
determining, when request information is transmitted from a client machine, whether or not the request information corresponds to command information in the same session stored in the memory; and
executing an exceptional process when the information does not correspond.

8. The method according to claim 7, wherein
the command information stored before in the same session is deleted when the command information is stored.

9. A method for suppressing an unreasonable screen shift by a server machine when an input/output screen of a Web application is generated, comprising:
determining the business class based on a combination of a command name and a data storage name transmitted from a client machine;
determining a JSP file from among the plural types of JSP files according to result information obtained from the business class;
extracting the command name and a corresponding data Bean name according to input/output screen information obtained from the JSP files, and storing the session class associated with a session identification number;
determining whether or not, when a data Bean name and a command name are received from a client machine, the data Bean name and the command name correspond to the data Bean name and the command name in the same session stored in the session class; and
executing an exceptional process when it is determined that the names do not correspond.

10. The method according to claim 9, wherein
when the command name and the corresponding data Bean name are associated with a session identification number, the command name and the data Bean name of the same session identification number stored before in the session class are deleted.

11. The method according to claim 9 or 10, wherein
a command name indicated in a position of a JSP expansion tag is extracted according to input/output screen information obtained from the JSP files.

12. The method according to claim 11, wherein
a command name indicated in a position of a FORM tag is extracted according to input/output screen information obtained from the JSP files.
